(19) United States
(12) Patent Application Publication
(10) Pub. No.: US 2006/0214894 A1
(43) Pub. Date: Sep. 28, 2006

(54) Power wiring structure and method for a plurality of driver chips on a display panel

(76) Inventors: Wei-Chung Cheng, Niausung Township (TW); Yi-chan Chen, Madou Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/178,298

(22) Filed: Jul. 12, 2005

(30) Foreign Application Priority Data
Mar. 28, 2005 (TW) 094109633

(51) Int. Cl. G09G 3/36

(52) U.S. Cl. 345/87

(57) ABSTRACT

In a power wiring structure and method for a plurality of driver chips on a display panel, the display panel has a panel routing line thereon, each of the driver chips has a power line therewithin, and the power line is connected in parallel to the panel routing line. Due to the parallel connection of the power line and the panel routing line, the power wiring structure has an extremely low resistance, and thereby the power consumption resulted from the power wiring structure is very low.

### FIELD OF THE INVENTION

The present invention is related to a power wiring structure in a display, and more particularly, to a power wiring structure and method for a plurality of driver chips on a display panel.

### BACKGROUND OF THE INVENTION

In a flat panel display, the cost of the peripherals in a display module and the substrate for the combination of the display panel with the peripherals is much concerned. For example, FIG. 1 is a schematic diagram of a conventional power wiring structure in a liquid crystal display (LCD) that has a liquid crystal display panel 10 and several driver chips 12 mounted on the panel 10 for driving a thin film transistor (TFT) array 14. To provide electric power for the driver chips 12, a printed circuit board (PCB) or flexible printed circuit board (FPC) 16 is connected to the liquid crystal display panel 10 to serve as a power line substrate, on which a power line 18 is provided for each of the driver chips 12 to connect thereto. However, in the case of providing the power line 18 by the PCB or FPC 16, the cost of the display module will be increased, and thus, this case is avoided desirably in consideration of cost. Furthermore, chip-on-glass (COG) is on the trend to package the driver chips to the display panel of a flat panel display, and therefore, using the power line substrate for power wiring may not meet demands. Accordingly, it is proposed to use a panel routing line on the liquid crystal display panel to serve as the power line, in replacement of the conventional power line substrate. Unfortunately, a panel routing line on a display panel has a higher resistance, and it still seems impossible to costly produce a panel routing line on a liquid crystal display panel to have extremely low resistance thereof, since the panel routing line is manufactured by TFT process. Advantageously, the higher resistance of the panel routing line results in higher power consumption.

Therefore, it is desired a power wiring structure that could be directly formed on a display panel and will have extremely low resistance thereof.

### SUMMARY OF THE INVENTION

One object of the present invention is to provide a power wiring structure for a plurality of driver chips on a display panel, which is directly formed on the display panel and has an extremely low resistance thereof.

In a power wiring structure for a plurality of driver chips on a display panel, according to the present invention, the display panel has a panel routing line thereon, each of the driver chips has a power line therewithin, and the power line is connected in parallel to the panel routing line. As a result, the total resistance of the power wiring structure is extremely low, due to the fact that the power line within the driver chip has a sheet resistance approximately ⅕ to 1/10 as large as that of the panel routing line, and the effective resistance is reduced when the power line and the panel routing line are connected in parallel. Since the total resistance of the power wiring structure is reduced, the power consumption becomes lower.

### BRIEF DESCRIPTION OF DRAWINGS

These and other objects, features and advantages of the present invention will become apparent to those skilled in the art upon consideration of the following description of the preferred embodiments of the present invention taken in conjunction with the accompanying drawings, in which:

FIG. 1 shows a conventional power wiring structure in a liquid crystal display; and

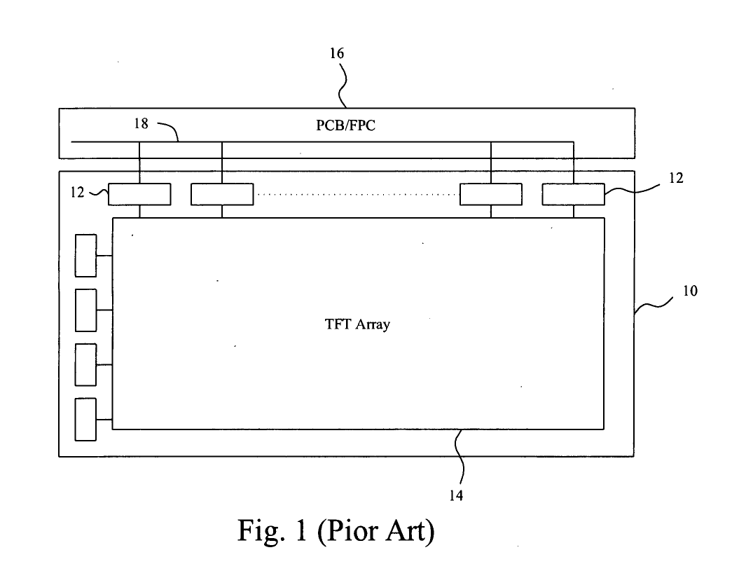

FIG. 2 shows a power wiring structure in a liquid crystal display according to the present invention.

### DETAILED DESCRIPTION OF THE INVENTION

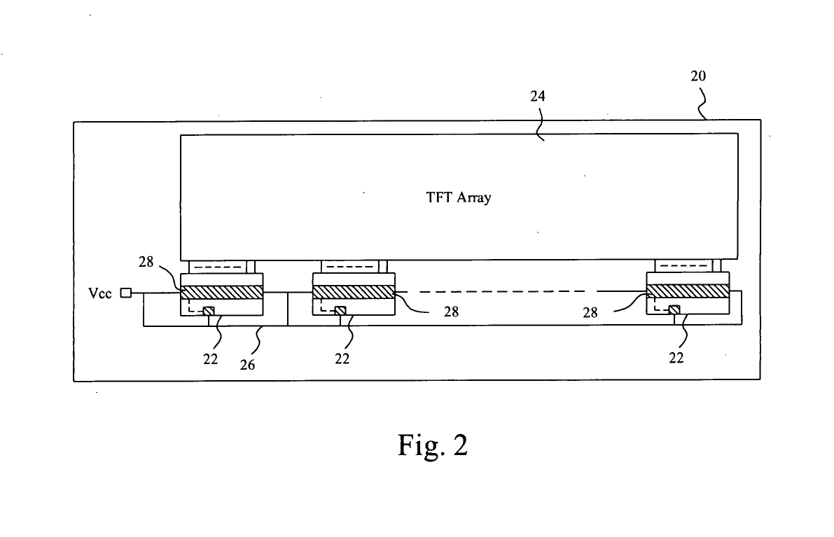

FIG. 2 shows a power wiring structure in a liquid crystal display according to the present invention. On a liquid crystal display panel 20, several driver chips 22 are mounted for driving a TFT array 24 of the display panel 10. For providing a power wiring structure, the display panel 20 has a panel routing line 26 thereon, each of the driver chips 22 has a power line 28 therewithin, and the power line 28 and the panel routing line 26 are connected in parallel. The power line is manufactured by semiconductor process to manufacture the integrated circuit of the driver chip 22, and typically, the power line 28 is made of low-resistive metal, such as aluminum and copper. In addition, the driver chip 22 in other embodiment may have more power lines connected in parallel to the panel routing line 26. It is known that the sheet resistance of the power line 28 within the driver chips 22 is ⅕ to 1/10 as large as that of the panel routing line 26 on the display panel 20, since the power line 28 is manufactured by semiconductor process. Also, it is known that the effective resistance of two resistors connected in parallel is certainly lower than that of either one of the two resistors. As a result, the power wiring structure formed by connecting the power line 28 and the panel routing line 26 in parallel has an extremely low resistance, and therefore the power consumption resulted from the power wiring structure is very low. Furthermore, since the power wiring structure is obtained by connecting the power line 28 within the driver chip 22 and the panel routing line 26 on the display panel 20 in parallel, it is advantageous to the packaging of the driver chips 22 to the display panel 20 by COG process.

Referring to FIG. 2, in a power wiring method for the driver chips 22 on the display panel 20, the panel routing line 26 is selected, each of the driver chips 22 is also selected for the power line 28 therewithin, and each of the power lines 28 is connected in parallel to the panel routing line 26.

Apparently, the power wiring structure having a power line within a driver chip and a panel routing line on a display panel is also applicable for any other flat panel display.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A power wiring structure for a plurality of driver chips on a display panel, comprising:
a panel routing line on the display panel; and
each of the plurality of driver chips having a power line therewithin connected in parallel to the panel routing line.

2. The power wiring structure of claim 1, wherein the power line is made of a metal.

3. A power wiring method for a plurality of driver chips on a display panel, each of the plurality of driver chips having a power line therewithin, the method comprising the steps of:
selecting a panel routing line on the display panel; and
connecting each of the power lines in parallel to the panel routing line.
